(19) United States
(12) Patent Application Publication
(10) Pub. No.: US 2015/0100511 A1
(43) Pub. Date: Apr. 9, 2015

(54) SYSTEM AND METHOD FOR RECRUITMENT

(71) Applicant: ABHIMAN TECHNOLOGIES PRIVATE LIMITED, Bangalore (IN)

(72) Inventors: Abhijit KHASNIS, BANGALORE (IN); Manjunath Sannappa TALWAR, BANGALORE (IN)

(73) Assignee: ABHIMAN TECHNOLOGIES PRIVATE LIMITED, BANGALORE (IN)

(21) Appl. No.: 14/507,864

(22) Filed: Oct. 7, 2014

(30) Foreign Application Priority Data
Oct. 7, 2013 (IN) 4525/CHE/2013

(51) Int. Cl. G06Q 10/10

(52) U.S. Cl. CPC G06Q 10/1053
USPC 705/321

(57) ABSTRACT

A recruitment system (100) and method are provided, The recruitment system (100) includes a database (110) and a server (108) operatively coupled to the database, wherein the server (108) includes a recruitment processing application (112). The recruitment processing application (112) is configured to receive notice period information corresponding to job seekers, store the notice period information corresponding to profiles of the job seekers in the database (110), and allow searching the profiles of job seekers based on notice period information.

### BACKGROUND

1. Field of the Subject Matter

The subject matter relates to the field of recruitment, more particularly but not exclusively, to an online recruitment technique.

2. Discussion of related field

Conventionally, employers seeking to recruit generally post job vacancies on their websites and receive profiles from interested job seekers. This conventional approach limits the employers' ability to reach a large number of potentially interested job seekers. Further, the instant approach compels job seekers to regularly visit websites of various companies to create a list of job openings. Furthermore, even if an employer were to recruit a job seeker using the instant approach, the job seeker will be able to join the employer only after a certain period of time, in many scenarios, For example, the job seeker, who might be currently employed with another employer, will have to resign and serve notice period, before joining the new employer. The aforementioned delay in joining the new employer can not only have an adverse effect on the operations of the new employer, but also necessitates employers to carry out human resource planning well in advance, which is not always possible given the dynamics of business.

Online job portals address some of the drawbacks of the above-discussed conventional approach. Such job portals allow job seekers to register themselves, while enabling employers to post job opportunities. Job seekers can search for job opportunities using the portal, while employers can search job seekers who may satisfy their requirement. Some of the drawback that are addressed by such job portals include, enabling employers to reach a large number of potentially interested job seekers and enabling job seekers to search for job opportunities at a single destination, instead of individually visiting websites of employers. However, a key drawback still remains unsolved, which is, even if an employer were to recruit a job seeker using the instant approach, the job seeker will be able to join the employer only after a certain period of time, in many scenarios, as discussed earlier.

In light of the foregoing discussion, there is a need for an improved technique for enabling online recruitment.

### SUMMARY

The invention provides a recruitment system. The system comprises at least one database; and at least one server operatively coupled to the at least one database, wherein the server comprises at least one recruitment processing application configured to: receive notice period information corresponding to job seekers; store the notice period information corresponding to profiles of the job seekers in the database; and allow searching the profiles of job seekers based on notice period information.

There is also provided a method of recruitment, Wherein the method comprises receiving notice period information corresponding to job seekers; storing the notice period information corresponding to profiles of the job seekers in a database; and allowing searching the profiles of job seekers based on notice period information.

### BRIEF DESCRIPTION OF THE DRAWINGS

Embodiments are illustrated by way of example in the Figures of the accompanying drawings, in which like references indicate similar elements and in which:

FIG. 1 illustrates an example block diagram of an online recruitment system 100, in accordance with an embodiment;

FIG. 2 is a flow diagram 200 of an exemplary method from the job seeker's perspective, in accordance with an embodiment; and

FIG. 3 is a flow diagram 300 of an exemplary method from the recruiter's perspective, in accordance with an embodiment.

### DETAILED DESCRIPTION

### I. Overview

II. Online recruitment system
III. Exemplary method from job seeker's perspective
IV. Exemplary method from recruiter's perspective

### V. Conclusion

### I. Overview

An embodiment discloses an online recruitment method. The method includes, job seekers submitting information to an online recruitment system. The information submitted by a job seeker includes notice period to be served by the job seeker, or equivalent information. The equivalent information, for example, can be, last date with the current employer of the job seeker and date on which the job seeker can report to a new job, among other such equivalent information. An employer can use the online recruitment system to search job seekers based on the above discussed information, among other search criteria the employer may choose to use. The instant method enables employers to recruit job seekers who have the capability to join the employers within a period preferred by the employers. Further, enabling recruiters to search for job seekers based on new job offer information, will allow the recruiters to judge job seekers based on their current value in the market.

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one with ordinary skill in the art that the present invention may be practiced without these specific details. In other instances, well-known methods, procedures, devices and networks have not been described in detail so as not to unnecessarily obscure aspects of the embodiments. Within the scope of the detailed description and the teachings provided herein, additional embodiments, application, features, and modifications are certainly recognized by a person skilled in the art. Therefore, the following detailed description is not to be taken in a limiting sense.

In this document, the terms “a” or “an” are used, as is common in patent documents, to include one or more than one. in this document, the term “or” is used to refer to a nonexclusive “or,” such that “A or B” includes “A but not B,” “B but not A,” and “A and B,” unless otherwise indicated.

### II. Online Recruitment System

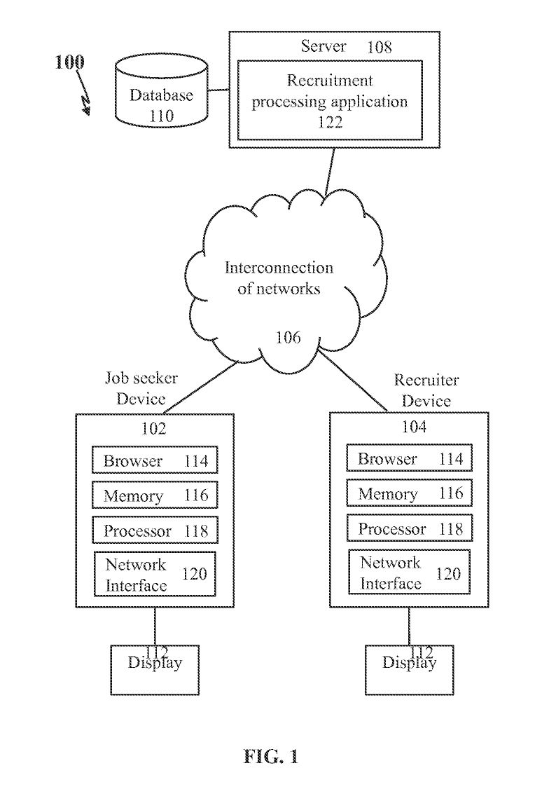

FIG. 1 illustrates an example block diagram of an online recruitment system 100, in accordance with an embodiment. The recruitment system 100 includes a job seeker device 102, a recruiter device 104 and a server 108 communicating through an interconnection of networks 106. Although, there is only one job seeker device 102, one recruiter device 104 and one server 108 depicted in FIG. 1, a person skilled in the art will understand that there can be multiple job seeker device 102 and recruiter device 104 associated with a server 104; and multiple servers 104 can also be incorporated.

The job seeker device 102 and the recruiter device 104 can be an electronic device, which is capable of running software applications derived from complied sequence of instructions stored in a memory, including but not limited to, personal computers, smart phones, tablet personal computers, net books and laptops. Hereinafter, the job seeker device 102 or the recruiter device 104 may also referred to as “electronic device”. The electronic device includes a processor 118 and a memory 116 associated with the processor 118, a network interface 120 and a browser 114. Further, there can be a display 112 associated with the electronic device.

The processor 118 is configured to communicate with the components of the electronic device including the display 112 and manage their operations by executing the instructions and other data stored in the memory 116. The processor 118 can include at least one of, one or more general purpose processor, one or more multi core processors, one or more graphics processors and one or more application specific processor, among others.

Memory 116 can include both volatile memory and nonvolatile memory, which can be used by the processor 118 to store temporary data and permanent data or instructions.

The network interface 120 is configured to allow the electronic device to communicate with the interconnection of networks 106 using at least one of, wired or wireless communication standards, not limited to Ethernet and 802.11a, 802.11b, 802.11g and 802.11n.

The interconnection of networks 106 is configured to establish reliable con between the electronic device and server 108. The interconnection of networks 106 can include, but not limited to, one or more Internet Service Providers (ISI's), one or more networks, one or more telephone exchanges, one or more servers, and one or more wired or wireless mediums for interconnections.

The display 112 associated with the client device 102 can be of any know display technology including, but not limited to, cathode ray tube display, Liquid Crystal Display (LCD), Light Emitting Diode (LED) display, plasma display, Organic-Light Emitting Diode display (OLED) and Electroluminescent Display (ELD).

The client device includes a browser 114. The browser 114 is a software application, which includes a sequence of instructions stored in the memory 112. The sequence of instructions when executed by the processor 110 allows the electronic device to view or download content from the server 108 through the interconnection of networks 106. The content may include, but not limited to, text, files, audio, video, images and animations. A number of protocols may be used by the browser 114 to fetch such content from the server 108, such as HTTP (Hyper Text Transfer Protocol), FTP (File Transfer Protocol') and HTTPS (Hyper Text Transfer Protocol Secure)_{;} among other application layer protocols.

The server 108 can be a physical computer executing server applications. The server 108 is configured to run one or more applications and share resources with one or more electronic devices. The server 108 is communicatively coupled to the database 110. The server includes a recruitment processing application 122. The recruitment processing application 122 allows a job seeker connected to the server 108, using the job seeker device 102, to register onto the server 108.

In an embodiment, once registered or during the process of registration, the recruitment processing application 122 receives from the job seeker, information corresponding to notice period to be served by the job seeker, or equivalent information. The equivalent information, for example, can be, last date with the current employer of the job seeker and date on which the job seeker can report to a new job, among other such equivalent information. Such information can be referred to as notice period information.

In an embodiment, once registered or during the process of registration, the recruitment processing application 122 receives from the job seeker, information corresponding to one or more jobs offered to the job seeker. The information corresponding to one or more jobs offered to the job seeker can include, for example, one or more of, name of the company, date of joining, designation, salary, job responsibilities, location and incentives, among others. Such information can be referred to as new job offer information.

In an embodiment, once registered or during the process of registration, the recruitment processing application 122 receives from the job seeker, information corresponding to his current employment. The information corresponding to the current employment can include, for example, one or more of, name of the company, date of joining, last date with the employer, designation, salary, job responsibilities, location and incentives, among others. Such information can be referred to as current employment information.

In an embodiment, once registered or during the process of registration, the recruitment processing application 122 receives from the job seeker, information corresponding to his past employment. The information corresponding to the past employment can include, for example, one or more of, name of the company, date of joining, date of leaving, designation, salary, job responsibilities, location and incentives, among others. Such information can be referred to as past employment information.

In an embodiment, once registered or during the process of registration, the recruitment processing application 122 receives from the job seeker, personal information and professional information. The information sought from the job seeker can include one or more of, or equivalent of, but not limited to, name, location preference, current location, contact details, experience, skill set, visa status, academic details and professional trainings undertaken, among others. Such information can be referred to as personal and professional information.

Further, the recruitment processing application 122 stores information received from a job seeker in the database 110.

The recruitment processing application 122 allows a recruiter connected to the server 108 using the recruiter device 104 to register with the recruitment processing application 122.

In an embodiment, the recruitment processing application 122 allows a recruiter to search for job seekers using notice period information as search criteria.

In an embodiment, the recruitment processing application 122 allows a recruiter to search for job seekers using notice period information and new job offer information.

In an embodiment, the recruitment processing application 122 allows a recruiter o search for job seekers using notice period information, new job offer information and current employment information.

In an embodiment, the recruitment processing application 122 allows a recruiter to search for job seekers using notice period information, new job offer information, current employment information and past employment information.

In an embodiment, the recruitment processing application 122 allows a recruiter to search for job seekers using notice period information, new job offer information, current employment information, past employment information and personal and professional information.

In light of the description, a person skilled in the art can think of combinations to be enabled for searching job seekers' profiles.

In an embodiment, the server 108 includes an authentication module, wherein the authentication module is configured to register, verify, validate and maintain a log of the users requesting access to the recruitment processing application 122.

The recruitment system 100 enables job seekers to conceal their identity from the recruiters. The recruiters, upon short-listing or otherwise, can request a job seeker to reveal his identity. The identity of the job seeker will be revealed to the recruiter upon authorization from the job seeker.

### III. Exemplary Method from JOB Seeker's Perspective

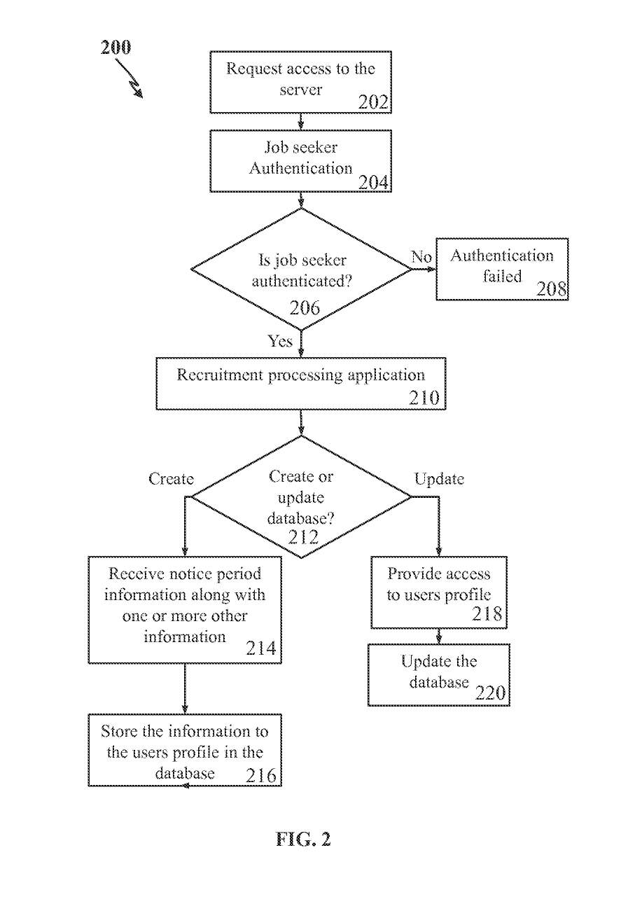

FIG. 2 is a flow diagram 200 of an exemplary method from the job seeker's perspective, in accordance with an embodiment. At stage 202, a job seeker requests access to the server 108, though the browser 114. At stage 204, the server 108 receiving the request forwards it to an authentication module associated with the server 108. At stage 206, the authentication module receives the job seeker's credentials though the browser 114 and verifies them by comparing them against the credentials already stored in the database 110. If the credential match, then at stage 210 the job seeker's device 102 is provided access to the recruitment processing application 122, else at stage 208, the job seeker's device is denied access to the recruitment processing application 122.

In an embodiment, the job seeker is allowed to register onto the server 108 before requesting access to the recruitment processing application 122. Further, during registration, the job seeker can be assigned with unique credentials for future access to the recruitment processing application 122. The credentials will be stored in the database 110 against the respective job seeker's profile.

At stage 212, the recruitment processing application 122 allows the job seeker to either create a profile or update job seeker's profile in the database 110. If the job seeker chooses to create a profile, then at stage 214, the recruitment processing application 122 receives notice period information. Further, at stage 214, the recruitment processing application 122 may also receive one or more of new job offer information, current employment information, past employment information, and personal and professional information. Further, at stage 216, the Information received from the job seeker is stored in the database 110.

On the other hand, at stage 212, if the job seeker chooses to update the profile, then at stage 218, the job seeker is provided access to the profile for updating. The updated profile is stored in the database 110, at stage 220.

In an embodiment, the notice period information may not be provided at the time of registration. However, it may be updated by the job seeker subsequently, so that his profile becomes searchable by the recruiters.

### IV. Exemplary Method from Recruiter's Perspective

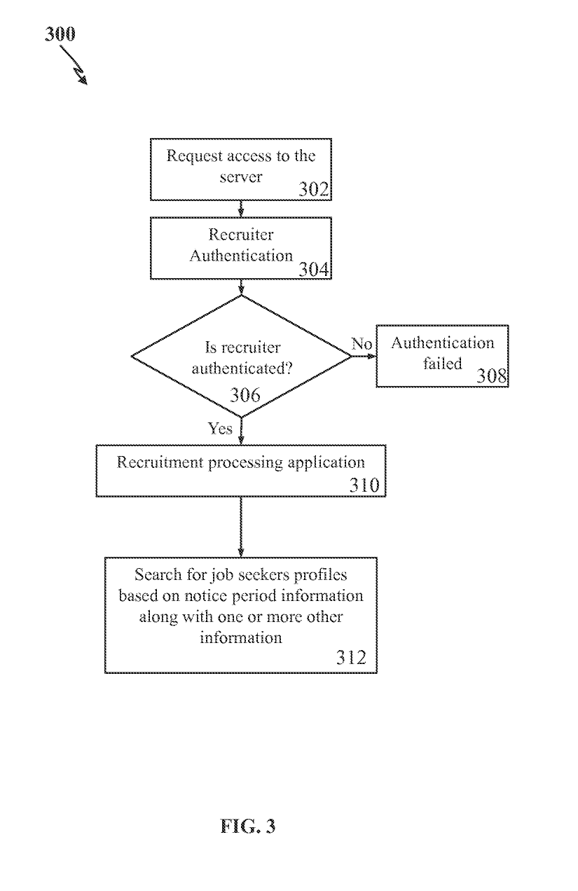

FIG. 3 is a flow diagram 300 of an exemplary method from the recruiter's perspective, in accordance with an embodiment. At stage 302, a recruiter requests access to the server 108, though the browser 114. At stage 304, the server 108 receiving the request forwards it to an authentication module associated with the server 108. At stage 306, the authentication module receives the recruiter's credentials though the browser 114 and verifies them by comparing them against the credentials already stored in the database 110. If the credential matches, then at stage 310 the recruiter's device 102 is provided access to the recruitment processing application 122, else at stage 308, the recruiter's device is denied access to the recruitment processing application 122.

In an embodiment, the job seeker is allowed to register onto the server 108 before requesting access to the recruitment processing application 122. Further, during registration, the recruiter can be assigned with unique credentials for future access to the recruitment processing application 122. The credentials will be stored in the database 110 against the respective recruiter's profile.

At stage 312, the recruitment processing application 122 allows the recruiter to search for job seekers' profiles based on notice period information. Further, recruiter may also search job seekers based on one or more of new job offer information, current employment information, past employment information, and personal and professional information.

In an embodiment, the recruitment processing application 122 allows recruiters to save search criteria, and automatically filter profiles of job seeker based on the saved search criteria. Information corresponding to the filtered profiles can be communicated to the recruiters by way of notification, even when they are not logged into the server 108. The notification, for example, can be an SMS, email or voice mail notification, among others.

### V. Conclusion

The embodiments enable recruiters to search for job seekers based on notice period information. Hence, they can target those job seekers who can take up the new job within a period desired by the recruiters, which is not enabled by conventional technologies.

The embodiments further enable recruiters to search for job seekers based on new job offer information. Hence, they can judge job seekers based on their current value in the market, which is not enabled by conventional technologies.

The processes described above is described as a sequence of steps, this is solely for the sake of illustration. Accordingly, it is contemplated that some steps may be added, some steps may be omitted, the order of the steps may be re-arranged, or some steps may be performed simultaneously. The example embodiments described herein may be implemented in an operating environment comprising software installed on a computer, in hardware, or in a combination of software and hardware. Some of the embodiment may also be directed to a sequence of instructions stored in a computer readable medium, such that, the sequence of instructions when executed by one or more processing devices allows the processing device to operate as described herein. The computer readable medium can include any primary storage devices or secondary storage devices.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given herein.

What is claimed is:

1. A recruitment system, wherein the system comprises:
at least one database; and
at least one server operatively coupled to the at least one database, wherein the server comprises at least one recruitment processing application configured to:
receive notice period information corresponding to job seekers;
store the notice period information corresponding to profiles of the job seekers in the database; and
allow searching the profiles of job seekers based on notice period information.

2. The recruitment system according to claim 1, wherein the recruitment processing application is further configured to receive information from the job seekers corresponding to, one or more of, new job offer information, current employment information, past employment information, and personal and professional information.

3. The recruitment system according to claim 1, wherein the recruitment processing application is further configured to allow searching the profiles of job seekers based on, one or more of, new job offer information, current employment information, past employment information, and personal and professional information.

4. The recruitment system according to claim I, wherein the recruitment processing application is further configured to allow recruiters to save one or more search criteria, for searching profiles of job seekers and filter profiles of job seeker matching the saved search criteria.

5. The recruitment system according to claim 1, wherein the recruitment processing application is further configured to enable job seekers to conceal their identity from recruiters, and reveal their identity to one or more recruiters upon authorization from the job seekers.

6. A method of recruitment, wherein the method comprises:
receiving notice period information corresponding to job seekers;
storing the notice period information corresponding to profiles of the job seekers in a database; and
allowing searching the profiles of job seekers based on notice period information,

7. The method of recruitment according to claim 6, further comprising receiving information from the job seekers corresponding to, one or more of, new job offer information, current employment information, past employment information, and personal and professional information.

8. The method of recruitment according to claim 6, further comprising allowing searching the profiles of job seekers based on, one or more of, new job offer information, current employment information, past employment information, and personal and professional information.

9. The method of recruitment according to claim 6, further comprising allowing recruiters to save one or more search criteria for searching profiles of job seekers and filtering profiles of job seeker matching the saved search criteria.

10. The method of recruitment according to claim 6, further comprising enabling job seekers to conceal their identity from recruiters, and revealing their identity to one or more recruiters upon authorization from the job seekers.
